(19) United States
(12) Patent Application Publication
(10) Pub. No.: US 2012/0189892 A1
(43) Pub. Date: Jul. 26, 2012

(54) Removable Battery Pack and Replaceable Cartridges

(76) Inventor: Alma Gilgen, Cottonwood Heights, UT (US)

(21) Appl. No.: 13/356,829

(22) Filed: Jan. 24, 2012

Related U.S. Application Data
(60) Provisional application No. 61/436,321, filed on Jan. 26, 2011.

(51) Int. Cl. H01M 2/10; H01M 2/30

(52) U.S. Cl. 429/99; 429/121

(57) ABSTRACT

A battery pack comprises a housing with an interior chamber that is selectively accessible, a number of battery cell sleeves within the housing that receive a number of battery cells, a number of electrical contacts within the housing that establish an electrical connection between the battery cells and an electrical device, and a connector attached to the housing that selectively attaches the battery pack to the electrical device.

### RELATED DOCUMENTS

The present application claims benefit under 35 U.S.C. §119(e) of U.S. Provisional Application No. 61/436,321 filed Jan. 26, 2010. This application is herein incorporated by reference in its entirety.

### BACKGROUND

A growing number of cordless electrical devices utilize removable battery packs to supply electrical power to the device. An example of one of these cordless electrical devices is a cordless power drill. Removable battery packs include physical devices that couple the battery pack to the electrical device. The battery packs and electrical devices also include corresponding electrical contacts that convert electrical potential energy stored in the battery pack into electrical power that drives the electrical device. These battery packs often include a number of individual battery cells that alleviate attaching an electrical device to an external power supply.

While removable battery packs make the process of supplying power easier, they are still burdensome due to the variety of ways to mechanically and electrically connect the battery packs to the devices and the cost of replacement of the entire battery pack when individual battery cells deteriorate.

### BRIEF DESCRIPTION OF THE DRAWINGS

The accompanying drawings illustrate various examples of the principles described herein and are a part of the specification. The illustrated examples do not limit the scope of the claims.

FIG. 1a is a perspective view of an electrical device using a removable battery pack, according to one example of principles described herein.

FIG. 1b is a perspective view of an electrical device using a removable battery pack and an adaptor, according to another example of principles described herein.

FIGS. 2a-2c are multiple views of a removable battery pack and electrical device, according to another example of principles described herein.

FIGS. 2d-2e are multiple views of a complementary twisting connector corresponding to and matching with the twisting connector of FIG. 2a-2c, according to another example of principles described herein.

FIGS. 3a-3c are side views of a removable battery pack in the process of connecting to an electrical device, according to one example of principles described herein.

FIGS. 4a-4c are multiple views of battery cell sleeves, according to one example of principles described herein.

FIG. 5 is a front view of a battery cell, according to one example of principles described herein.

Throughout the drawings, identical reference numbers designate similar, but not necessarily identical, elements.

### DETAILED DESCRIPTION

As described above, one challenge in supplying power to cordless electrical devices through a removable battery pack is the growing variety of removable battery pack configurations that supply power to the electrical device and the corresponding mechanical and electrical coupling mechanisms of those battery packs.

Notably different brands of electrical devices may employ different types of connections within their battery packs. For example, some brands may use tower-type connections, while other brands use slide-on connections. Moreover, even brands with the same general types of connections within their respective battery packs may nonetheless be incompatible due to the tower or slide-on structure having a different size, shape, electrical contact, or other feature, or any combination of the foregoing. Even still further, a single manufacturer of electrical devices may employ different types of connections in their battery packs in order to ensure that battery packs of a particular voltage (e.g. 18 volt or 20 volt battery pack) are not used in electrical devices demanding a different voltage (e.g. 12 volt battery pack). Thus, users generally purchase battery packs specific to a particular brand, and in some cases specific to a particular product as even different products by the same brand may have incompatible batteries.

Another challenge arises as individual battery cells within the battery pack lose capacity to supply power and the battery pack eventually becomes unusable. Moreover, such battery packs may be sealed to prevent tampering with individual battery cells that may be combined in serial and/or parallel within the battery pack. Accordingly, if even a single battery cell loses power or becomes defective, the entire battery pack may be discarded in favor of a replacement battery pack. Additionally, under some conditions any number of cells within the battery pack can become imbalanced and, as a result, have a present state of charge that is substantially lower than the remaining cells in the pack. Imbalanced cells can severely impact the performance of the battery pack (e.g., run-time and/or voltage output) and can shorten the life of the battery pack. The battery pack may be welded or bonded together such that the battery pack is replaced with the failure of even a single cell.

In light of these and other issues, the present specification discloses systems for providing electrical power to cordless electrical devices. In particular, the present specification discloses a twist-lock removable battery pack. As a removable battery pack is depleted, the battery pack may be removed and recharged while a second battery pack is inserted and used with the electrical device. According to one example, battery packs, in one example, may be secured to the electrical device using a tower-type connection. In this example, a portion of the electrical device, such as the handle, defines an opening, and the removable battery pack includes a tower, post, column, or other insertion portion which is inserted into the opening on the electrical device to mechanically fasten and to electrically connect the battery pack to the electrical device. To charge the tower-type battery pack, a charger housing defines a similar opening within a charging station, and the tower portion of the battery pack is inserted into the opening in the charger housing to support the battery pack on the charger housing and to electrically connect the battery to the charging circuit.

According to another example, the electrical device makes use of a slide-on configuration. In the slide-on configuration, the electrical device housing includes a support portion, and the battery pack slides onto the support portion. The support portion and the battery pack each include inter-engaging connecting structures to physically connect the battery pack to the electrical device housing and to electrically connect the battery pack to the motor of the electrical device. To charge the slide-on battery pack, the charger housing includes a similar support portion, and the battery pack and the charger housing include similar inter-engaging connecting structure to physically connect the battery pack to the charger housing and to electrically connect the battery to the charging circuit.

In these examples, an attachment mechanism may electrically and mechanically connect the removable battery pack to an electrical device. In one example, the attachment mechanism includes a twisting connector extending from the battery pack. In this example, the battery pack is placed within the receptor of the electrical device and the battery pack is rotated relative to the electrical device and such rotation causes a twisting connector to selectively secure the battery pack in place relative to the electrical device. The battery pack may include a number of electrical contacts that connect with corresponding contacts of an electrical device when the twisting connector is inserted into the electrical device.

According to another example; an adaptor for a battery pack is disclosed. The adaptor includes a first electrical coupling mechanism that attaches to an electrical device; for example, a power drill having a tower-type or slide-on type connection. A second electrical coupling mechanism is included to attach to a battery pack having a twisting connection.

According to one example, the battery pack may include an interior chamber that is selectively accessible. For example, the battery pack may have a first portion and a second portion that are selectively movable relative to one another. For instance, the battery pack may have a clamshell construction such that the first portion and second portion of the battery pack rotate together to enclose the interior chamber. In another example, the battery pack may define a portion of the interior chamber. A lid may then be secured in place to enclose the interior chamber. In another example, the battery pack may open to provide end access, or may open to provide side access to the interior chamber.

The interior chamber houses a number of battery cell sleeves. The sleeves receive a number of battery cells, each battery cell being located within a respective sleeve of the interior chamber. When the interior chamber is accessible, each of the battery cells is independently interchangeable relative to other battery cells. According to one example these battery cells include asymmetrical features that serve as orienting mechanisms. For example, a cap may be placed at one end of a battery cell. The corresponding battery sleeve may then be configured such that if a user attempts to insert a battery into the sleeve with the cap leading, the battery will not fit or otherwise resist coupling. However, if the user attempts to insert a battery into the sleeve with the cap trailing, the battery may be inserted.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples. The various instances of the phrase “in one example” or similar phrases in various places in the specification are not necessarily all referring to the same example.

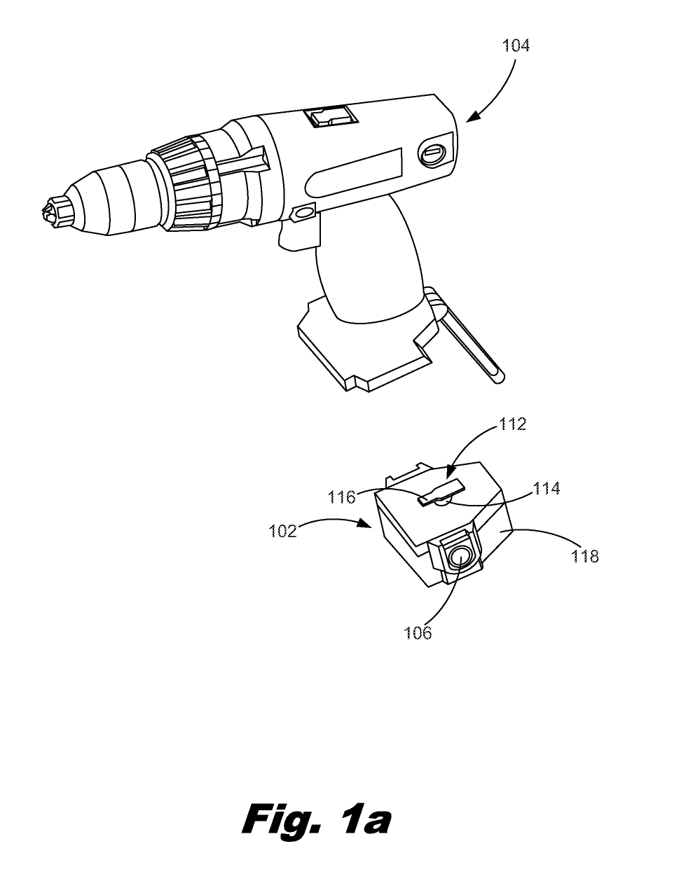

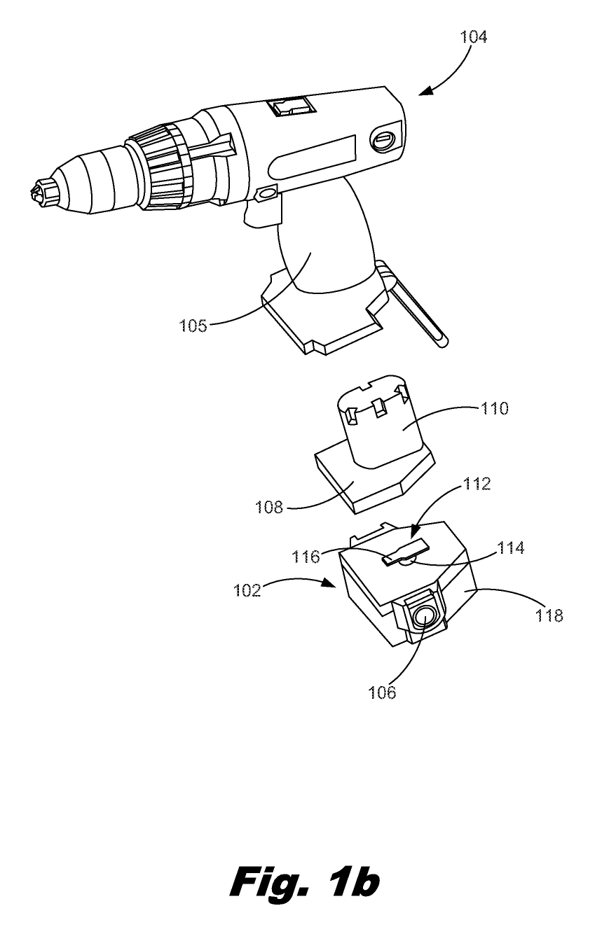

Referring now to the drawings, FIG. 1a is a perspective view of an electrical device (104) and a removable battery pack (102). For simplicity, the electronic device (104) depicted is a cordless power drill. However, other examples of electronic devices include, but are not limited to saws, rotary tools, routers, impact drivers, screwdrivers, flashlights, grinders, battery chargers, or any combination of the foregoing. The system may further include an adaptor (108) as depicted in FIG. 1b to indirectly couple the battery pack (102) to the electrical device (104).

According to one example, the electrical device (104) includes an electrical device housing (105) that defines a hollow portion therein. Inside the electrical device housing (105) there may be a number of elements that mechanically couple a removable battery pack (102) to the electrical device (104). The electrical device housing (105) may also include a number of elements that electrically couple the removable battery pack (102) to the electrical device (104) and supply power to the electrical device. For example, a number of leads or contacts may be provided adjacent an interior surface of the hollow portion of the electrical device housing (105), and the leads or contacts may be electrically connected with a motor that, when actuated, causes the electrical device (104) to draw power from a removable battery pack (102) or other power source.

The battery pack (102) may include a housing (118) into which a number of battery cells may be inserted, along with circuitry, signal conditioning, or other components used to transfer power from the battery pack (102) to an electrical device (104). The shape of the housing (118) and the battery pack (102) as depicted is for illustration and that the housing and battery pack may have other shapes. Examples of other shapes include, but are not limited to, circular, cylindrical, elliptical, irregular, tapered, triangular, trapezoidal, curved, or any other shape or topography, or combinations thereof.

In the example of FIG. 1a, a twisting connector (112) is attached to the housing (118). The twisting connector (112) may take any suitable form. In this example, the twisting connector (112) includes a post (114) extending from an upper surface of the housing (118). At a distal end of the post (114) is a plate (116). The plate (116) may be, as depicted in this example, asymmetrical. For example one end of the plate (116) may have a width or other dimension generally larger than a width or other dimension of an opposing side or portion. The plate (116) may be asymmetrical in order to, among other things, facilitate proper alignment with an electronic device (104) and/or adaptor. For instance, a wider portion of the plate (116) may be able to fit into a corresponding receiver in one alignment, thereby reducing the risk that a user will mate the battery pack (102) improperly with an electronic device (104) and/or adaptor.

According to one example, the electrical leads or contacts may be located on the twisting connector (112). For example, electrical contacts may be placed on the underside of the plate (116). These electrical contacts electriocally couple with the electrical device (104) and transfer power between batteries or another power source within the battery pack (102) and the electronic device (104). The transfer may be directly from the battery pack (102) to the electronic device (104), or may be passed through a number of adaptors.

According to one example, the removable battery pack (102) may include a self locking mechanism (106) that selectively locks the battery pack (102) in place relative to the electrical device (104) or adaptor when an electrical connection is established. The mechanism (106) may include, for example, a ramp, latch, detent, or other structure that, when mated with a corresponding structure in the electrical device or adaptor, causes the battery pack (102) to become substantially locked in place relative thereto. In this example, the self locking mechanism (106) may interact with elements within the electrical device (104) that, when mated, mechanically fasten the battery pack (102) to the electrical device. The self locking mechanism (106) may be employed to selectively release the battery pack (102) from the electrical device (104) and permit separation thereof.

According to an example, the interior of the battery pack may be accessed upon removal or release of a number of securing mechanisms or fasteners (not shown) of the battery pack (102). For example, a number of screws may attach opposing halves or sides of a battery pack (102). Upon removal of the number of fasteners, the battery pack (102) may be opened. Accordingly, a removable battery pack (102) may be selectively disassembled allow the interior of the battery pack to be accessed and individual battery cells removed, checked for capacity/life, replaced, or otherwise manipulated.

FIG. 1b is a perspective view of an electrical device (104), a removable battery pack (102), and an adaptor (108). The system (100) may include a removable battery pack (102) and an electronic device (104) similar to those described above.

In this example, the adaptor (108) may facilitate a connection between the electrical device (104) and the battery pack (102). The adaptor (108) permits generalized use of the battery pack (102), even in connection with electrical devices of various types and brands. For instance, products manufactured by particular manufacturers may have a specific style of attachment configuration for a removable, rechargeable power source. In one example, multiple adaptors may be available to match the particular configurations of any particular brand of electrical device. In this example, a number of adaptors that couple with a number of different brands of electrical devices may be sold as a kit or assembly.

Each of the above-described adaptors (108) mates with the battery pack (102). As a result, the same battery pack (102) may be attachable to any number of different devices, despite such devices having different battery pack attachment methods or configurations. For example, as depicted in FIG. 1a, the battery pack (102) can connect directly to a power tool or other device without the aid of an adaptor. For instance, the battery pack (102) may be specially designed for use with a particular device. The adaptors (108) may be available for other devices having different configurations. In the above-described examples, the adaptors (108) may be formed to match configurations of any number of brands of electrical devices including, for example, electrical devices made by the following companies: Black & Decker Corporation®, Robert Bosch GmbH® (Bosch® and Skil®), Chicago Electric®, KCD IP, LLC® (Craftsman®), Stanley Black & Decker® (DeWalt®), Hitachi, Ltd®, Makita Corporation®, Milwaukee Electric Tool Corporation®, Porter-Cable®, Emerson Prfessional Tools™ (Rigid®), and Ryobi Limited®, among others.

For example, the adaptor (108) of FIG. 1b includes a tower (110) comprising electrical leads or contacts that engage corresponding leads or contacts within the handle of the electrical device (104). In one example, the adaptor (108) may have a mechanism that selectively locks the adaptor (108), the battery pack (102), or combinations thereof in place relative to the electrical device (104) when an electrical connection is established. In this example the self locking mechanism may interact with elements within the electrical device (104) that when mated with the self locking mechanism, mechanically fasten the adaptor (108) to the electrical device. In another example, the battery pack (102) may have a mechanism that selectively locks the adaptor (108), the battery pack (102), or combinations thereof in place relative to the electrical device (104) when an electrical connection is established.

According to one example, the battery pack (102) includes a twisting connector (112). The twisting connector (112) may have any suitable configuration. As depicted in FIG. 1b, the twisting connector (112) may include a post (114) that extends from the upper surface of the housing (118) of the battery pack (102). At a distal end of the post (112), the twisting connector (112) may include a plate (116). The plate (116) may be offset from the upper surface of the battery pack (102), such that a gap is formed between a lower surface of the plate and the upper surface of the battery pack. The adaptor (108) may include a complementary channel (not shown). For instance, an opening may be formed on the lower surface of the adaptor (108). In this example, the plate (116) of the twisting connector (112) can be inserted into the opening on the adaptor (108). This channel may also establish an electrical connection with the battery pack (102).

By rotating the battery pack (102) relative to the adaptor (108), the plate (116) can rotate or otherwise move within the channel. The channel may be at least partially bounded at a lower surface thereof such that a lower surface or other mechanism restricts removal of the battery pack (102) from the adaptor (108) following rotation of the battery pack. Electrical leads or contacts may be positioned on the battery pack (102). For instance, electrical contacts on an upper or lower surface of the plate (116) may, upon being rotated a desired amount, engage or otherwise be placed in electrical communication with leads or contacts within the adaptor (108). Such leads or contacts may further be electrically coupled to leads, contacts, or other devices within the adaptor (108) and, via the adaptor (108), establish electrical communication with the electrical device (104). The battery pack (102) may also be selectively locked in place relative to the adaptor (108) and the electrical device (104). Such selective locking may be performed in any manner described herein or as would otherwise be appreciated by one skilled in the art in view of at least the disclosure herein.

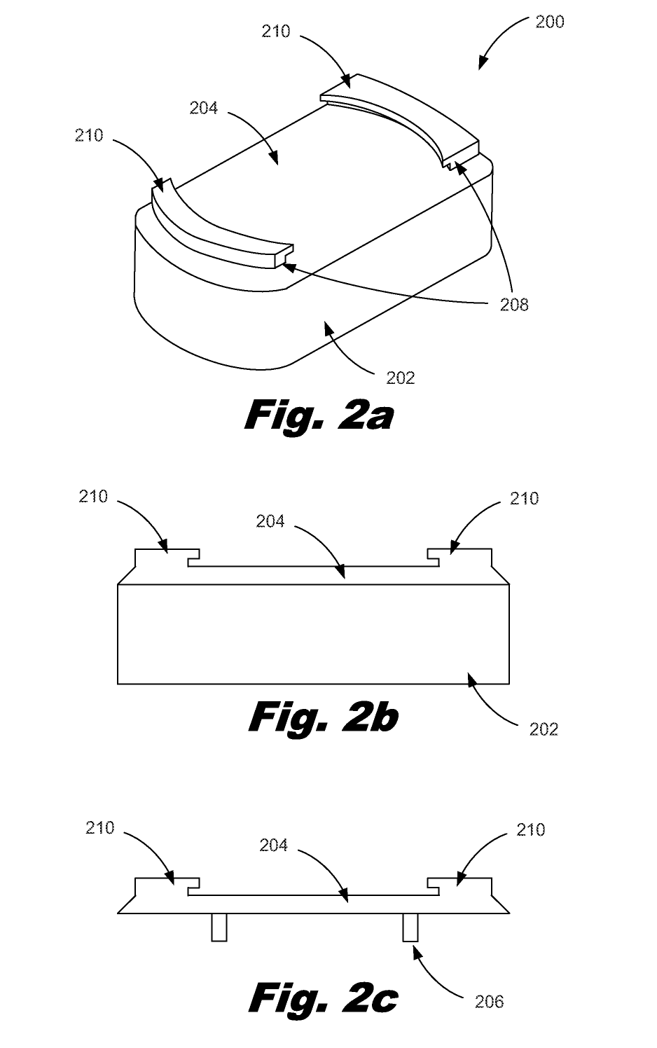

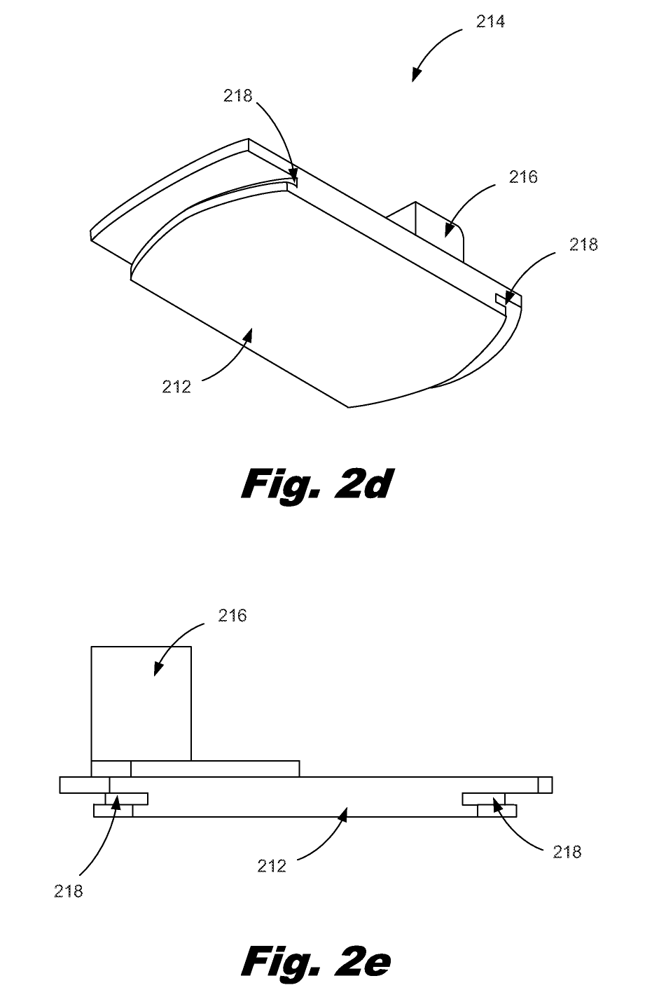

FIGS. 2a, 2b, and 2c are multiple views of a removable battery pack (200) that supplies power to an electrical device. The removable battery pack (200) may include an interior chamber that is selectively accessible. The interior chamber may be accessed upon removal or release of a number of securing mechanisms of the battery pack (200) as described above. For example, a number of screws may be inserted into a number of screw sleeves (206) to attach the lid (204) to the battery pack housing (202). The screw sleeves (206) may also serve as alignment features to ensure the battery cells are properly aligned within the interior chamber. While FIGS. 2a-2c depict a lid and housing configuration, other configurations are possible such as, for example, a clamshell construction. Similar to the battery pack depicted in FIGS. 1a and 1b, the interior chamber houses a number of battery cell sleeves. The sleeves receive a number of battery cells, each battery cell independently interchangeable relative to other battery cells within the pack.

The battery pack (200) may include a twisting connector (208) for attaching the battery pack (200) to an electrical device. The twisting connector (208) may have any suitable configuration. As depicted in FIG. 2a, the twisting connector (208) may include a number of plates (210) offset from the upper surface of the battery pack (200), such that a gap is formed between a lower surface of the plates (208) and the upper surface of the battery pack.

FIGS. 2d-2e are multiple views of a complementary twisting connector (212) corresponding to and matching with the twisting connector (208) of FIGS. 2a-2c, according to another example of principles described herein. The complementary twisting connector (212) couples the battery pack (FIG. 1a, 102) to an electrical device (FIG. 1, 104). According to one example, the complementary mechanism (212) may be attached to the electrical device directly. In another example, the complementary mechanism (212) may be attached to an adaptor (FIG. 1b, 108) that indirectly connects the battery pack to the electrical mechanism. FIGS. 2d-2e depict the complementary connector (212) attached to an adaptor (214) having a tower-type configuration. According to an example, the electrical device may have a receptor that receives a tower (216) positioned on the adaptor (214). Inside the receptor, there may be a number of elements that mechanically couple the battery pack (FIG. 2a, 200) to the electrical device and supply power to the electrical device.

The complementary mechanism may include a number of notched grooves (218) that receive the offset plates (FIGS. 2a-2c, 210). In this example, the plates (FIGS. 2a-2c, 210) of the twisting mechanism (FIGS. 2a-2c, 208) align with the notched grooves (218) and the battery pack is rotated relative to the adaptor (214) and such rotation may cause a selective lock to engage and selectively secure the battery pack (FIGS. 2a-2c, 200) in place relative to the electrical device. An electrical connection between the adaptor (214) and the battery pack (FIGS. 2a-2c, 200) may be formed as the offset plates (FIGS. 2a-2c, 210) and the notched grooves (218) are rotated to align with one another. For instance, electrical contacts on an upper or lower surface of the offset plates (FIGS. 2a-2c, 210) may, upon being rotated a desired amount, engage or otherwise be placed in electrical communication with leads or contacts within the adaptor (214). Such leads or contacts may further be electrically coupled to leads, contacts, or other devices within the adaptor (214) and which establish electrical communication with the electrical device (FIG. 1a, 104).

Additionally, the adaptor (214) may electrically connect the battery pack (FIG. 2a, 200) to the electrical device. The battery pack (FIG. 2a, 200) may also have a self locking mechanism that interacts with the adaptor (214) or other electrical device to selectively lock the battery pack in place relative to the adaptor or other electrical device when an electrical connection is established.

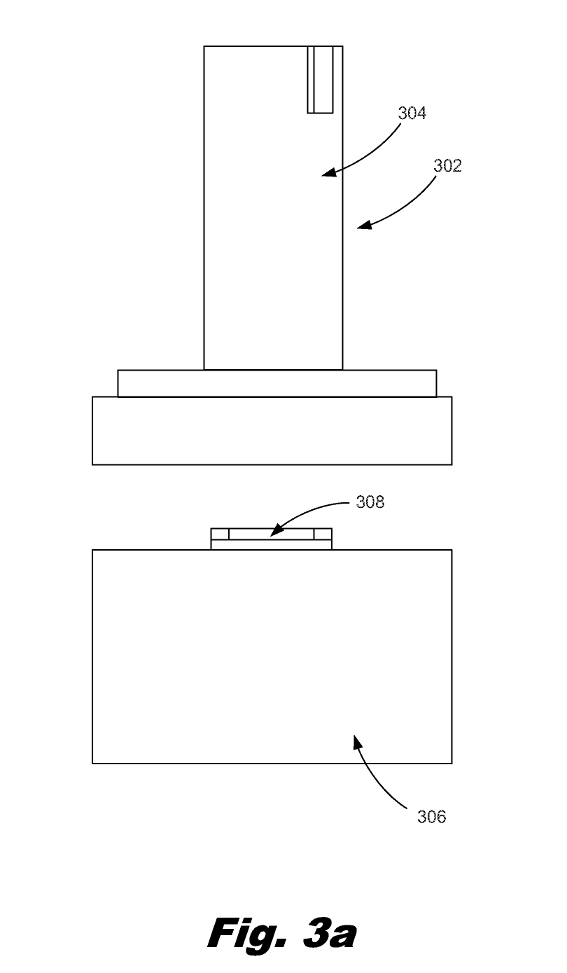

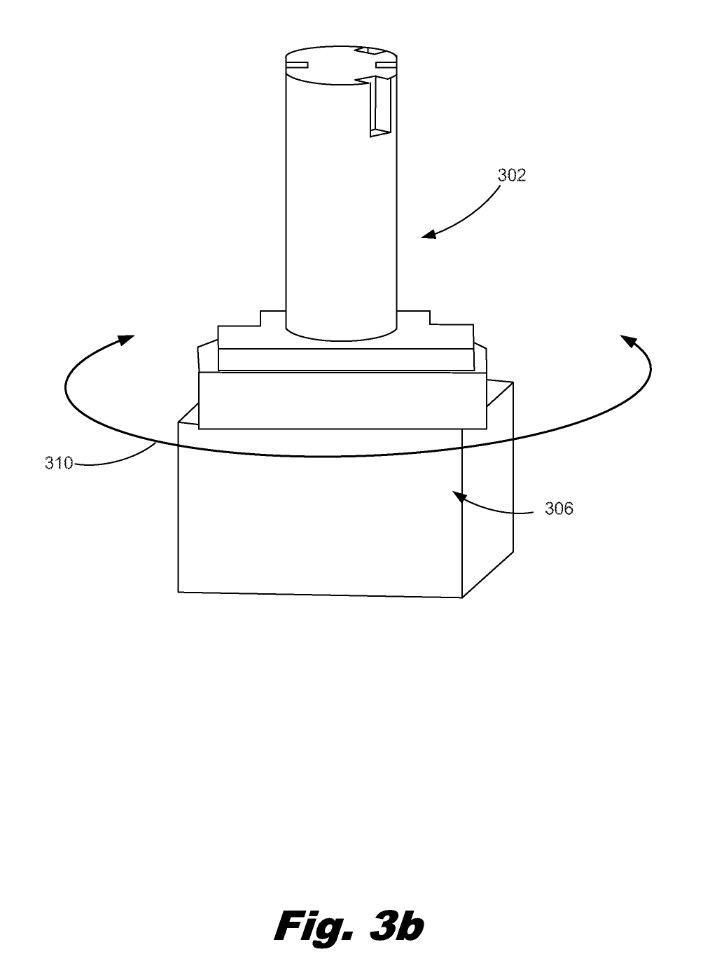

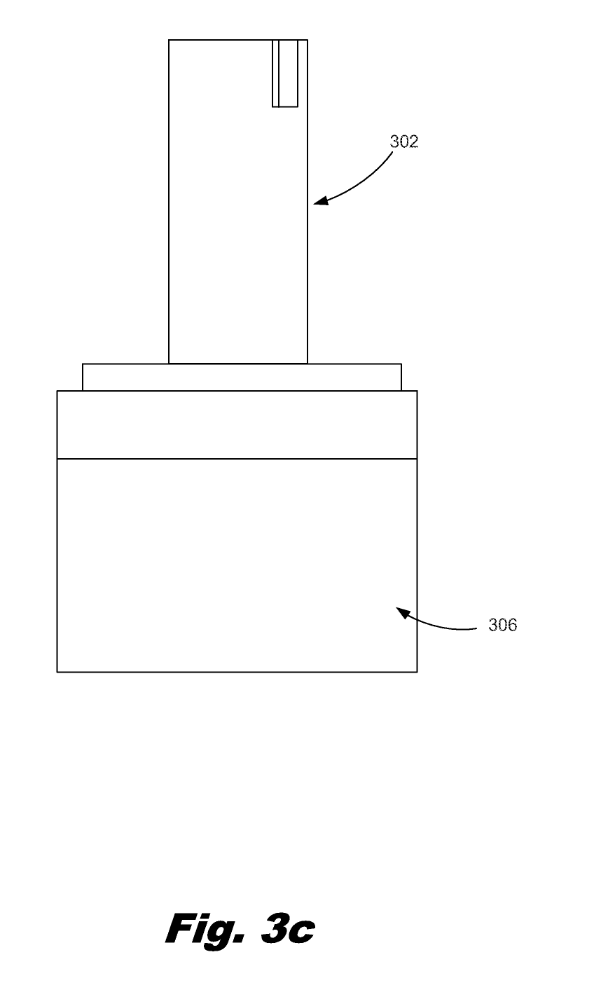

FIGS. 3a-3c are side views of a removable battery pack (306) in the process of connecting to a device structure (302). The battery pack (306) is illustrated as being attached to a device structure (302) having a tower-type configuration. According to an example, the device structure (302) may be an adaptor used to couple a battery pack to a power tool or other electrical device. In other examples, the device structure (302) represents a power tool or other device.

In examples where the battery pack (306) is attached to an electrical device directly or through the aid of adaptors, the battery pack (306) may be secured to the device structure (302) using a twisting connector (308). Examples of twisting connectors include but are not limited to the twisting connectors similar to those described above. The device structure (302) depicted is an adaptor using a tower-type connection, however such is merely provided for illustration and the device structure (302) may be any electrical device using any type of connection.

The battery pack (306) may include a twisting connector (308) extending from an upper surface of the battery pack (306). The device structure (302) can have a corresponding recess formed therein, such that at least a portion of the twisting connector (308) can be received within the device structure (302). As depicted in FIG. 3b, the twisting connector (308) may align with a corresponding groove, recess, or other opening in the device structure (302). That opening may be angled within the base surface of the device structure (302), such that as the twisting connector (308) is inserted into the recess, the battery pack (306) and the device structure (302) are out of alignment. The battery pack (306) is selectively engaged with the device structure (302) by, after receiving the twisting connector (308) within the device structure (302), twisting the battery pack (306) relative to the device structure (302) as indicated by arrow (310).

As depicted in FIG. 3c, following insertion of all or a portion of the attachment mechanism (308) of the battery pack (306) into such an opening, the battery pack can be rotated as described above. The battery pack (306) may be rotated so as to be aligned with the device structure (302). In one example the battery pack (306) may at least temporarily lock in place with respect to the device structure (302) once the battery pack and device structure are aligned for electrical communication. The degree by which the battery pack (306) is rotated to secure it to the device structure (302) may vary.

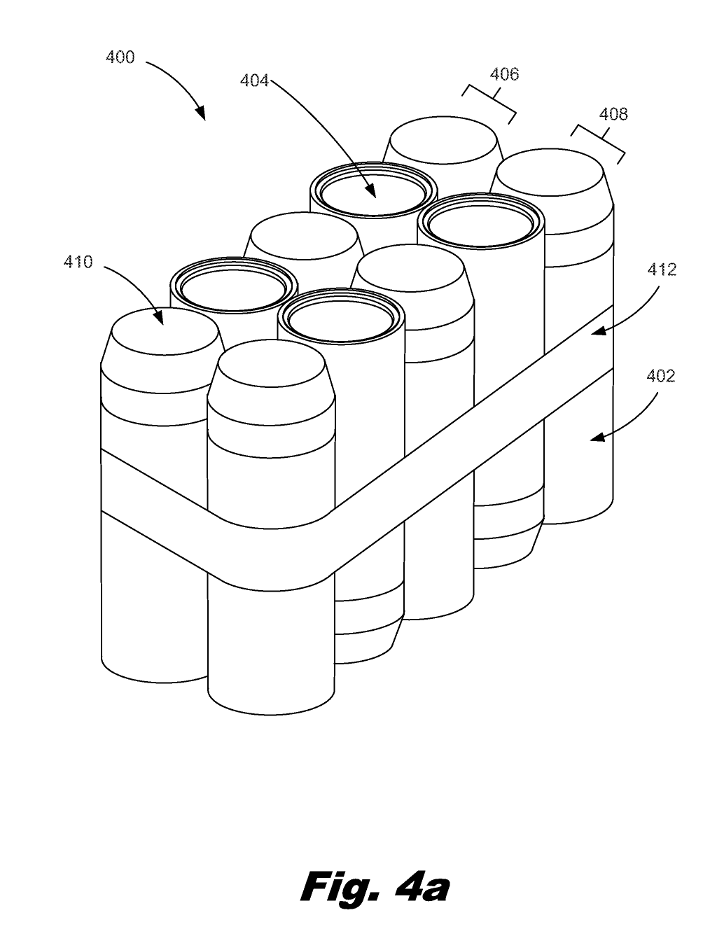

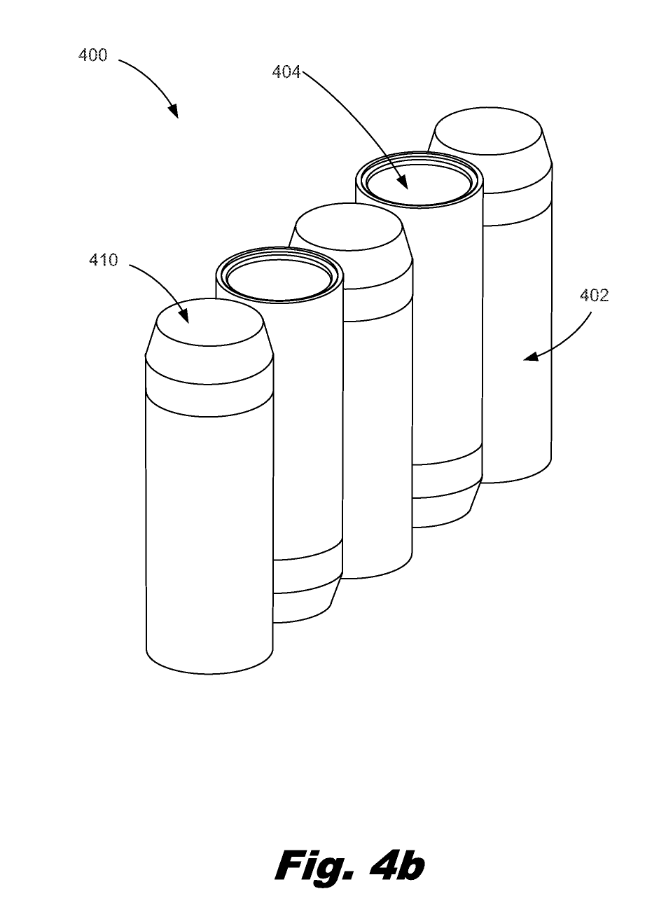

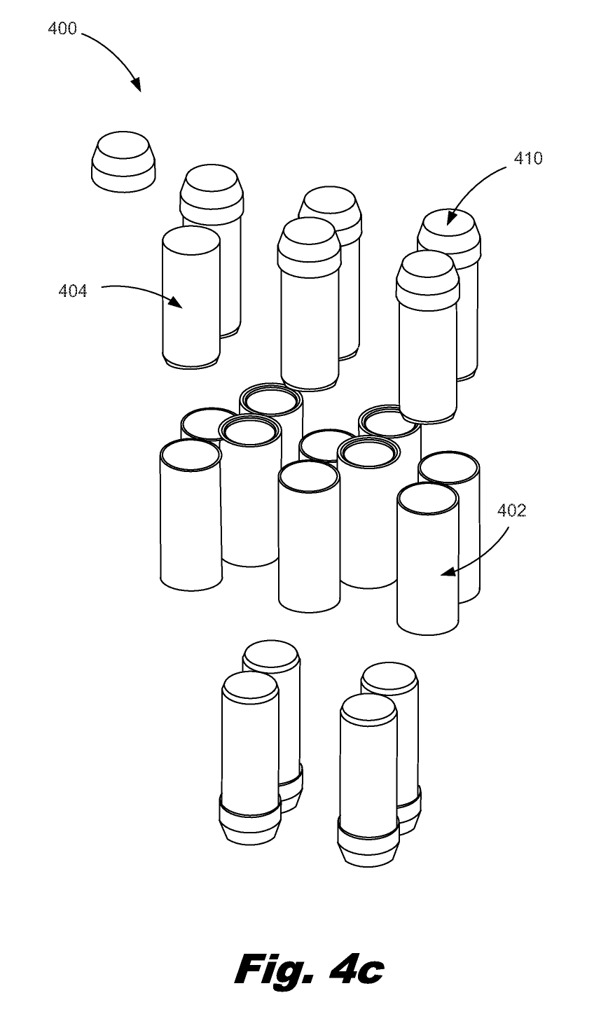

FIGS. 4a-4c are multiple views of a magazine (400) of battery cell sleeves (402) housed within a removable battery pack. A removable battery pack may be selectively disassembled to allow the interior of the battery pack to be accessed and individual battery cells (404) removed, checked for capacity/life, replaced, or otherwise manipulated. While FIG. 4a depicts ten battery cell sleeves (402) arranged in two rows, a magazine (400) may include any number of battery cell sleeves arranged in any fashion. For example, a magazine (400) may include a single row of five battery cell sleeves (402) as depicted in FIG. 4b. Interchangeable battery cells (404) may be inserted into the battery cell sleeves (402). The battery cells (404) may be placed in the sleeves (402) in an alternating manner such that within a row, cells alternate between upward and downward orientations. Electrical components, including circuitry, electrical contacts, and the like may then be selectively removable from individual battery cells (404). Allowing access to the individual battery cells (404) and electrical components in this fashion allows a user to remove a single cell or remove multiple cells without affecting the other cells. For example, if a single cell is defective, that cell can be replaced and the battery pack reassembled. Thus, a user can see a significant cost savings as a single cell (of possibly multiple cells) may be replaced, rather than requiring replacement of an entire battery pack.

According to an example, the cells contained in a first row (406) may be wired in series. As a result, the voltage potential of a single row may be the sum of the voltage potentials of each of the five cells in that row. For example, as depicted in FIG. 4a, if each of the battery cells of a first row (406) has a voltage potential of 2.4 volts, the voltage potential across the first row (406) would be 12 volts. The first row (406) may be connected to a second row (408) of cells such that the sum of all ten cells determines the voltage potential. Alternatively, the two rows (406, 408) may be wired in parallel. In wiring the rows in parallel, the voltage potential may remain constant, and equal to the voltage potential of a single row; however, the corresponding battery pack can have a higher current capacity. Thus, any arrangement of battery cells (404) in series, in parallel, or combinations thereof may be utilized to achieve a desired output voltage.

The magazine (400) may also include an orienting mechanism to ensure the battery cells are aligned correctly. For example, a cap (410) placed on individual battery cells (404) to orient the battery cell within the battery cell sleeve (402). For example, each of the sleeves (402) may have an orienting element such as a shelf, shoulder, taper, or other structure that allows the battery cells (404) to be placed within the corresponding sleeve in one direction. According to this example, if a battery cell (404) is misaligned within the sleeve (402), the cap (410) may resist insertion into the sleeve (402). However, if the battery cell (404) is properly aligned within the sleeve (402), the cap (410) may be inserted into the sleeve (402). This cap (410) may be useful to prevent user error in replacing the interchangeable battery cells (404). For example, if a user inserts a battery cell in a wrong direction, the battery pack may not work, or may result in damage to the battery pack. By providing an orienting mechanism such as a cap to attempt to ensure that the user inserts the battery cell (404) in the proper direction, damage or lost time can be prevented.

In some examples, the magazines (400) include sleeves (402) that are secured together. For example, the sleeves (402) may be secured using an adhesive (412). Other examples of devices to secure the sleeves together include, but are not limited to, mechanical fastener, glue, snaps and other connection mechanisms. In other examples, the sleeves (402) may be integrally formed as a single component or as a collection integrated components. The structure of the magazine (400) may also be suitable to prevent user error. For example, in FIG. 4a, the particular orientation has three rows of cells oriented in a first direction, while two rows of cells oriented in a second opposite direction. The interior of the battery pack into which the magazine (400) is positioned may also be structured to receive the magazine (400) if the cells are properly aligned.

FIG. 4c is an exploded view of battery cell sleeves (402), according to one example of principles described herein. Upon insertion of the cells (404) into the respective sleeves (402), the entire magazine (400) can be secured within the battery pack by any number of securing elements, and connected to electrical components used to convey power to the electrical device. Examples of securing elements include, but are not limited to interference fits, ribs, screws, latches, or other securing devices, or any combination of the foregoing that secure or stabilize the magazine (400) in the battery pack. Accordingly electrical conductivity elements such as, for example, contacts, leads, and wires can be securely placed relative to the battery cells (404) to make use of the power capacities of the battery cells. The sleeves (402) may have an interior opening that creates an interference fit relative to the cells (402) such that the cells (402) have very little relative motion when secured within the magazine (400).

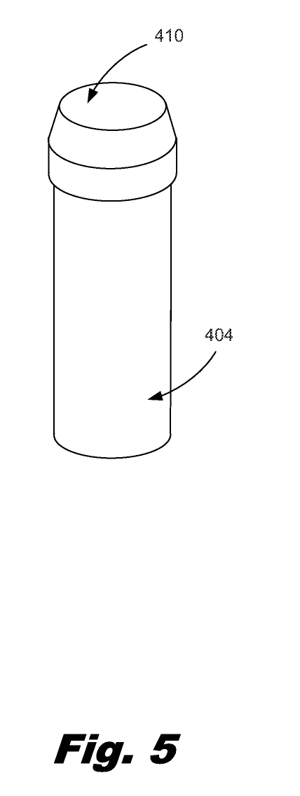

FIG. 5 is a front view of a battery cell usable in a removable battery pack. According to an example, the battery cell (404) may have a generally cylindrical shape and configuration. An asymmetrical feature such as cap (410) may be positioned at some portion of the cell (404). In an example, the cap (410) is selectively removable from the end of the battery cell (404).

As discussed herein, in one example, individual battery cells may be replaced, such that replacement of an entire battery pack can be avoided. Thus, a user may be able to purchase individual cartridges at a much lower cost than that of the entire battery pack. Moreover, disposal of a battery pack may include disposing of multiple battery cells that are operable. Indeed, in some cases, a single battery cell may have gone bad, such that disposal of an entire battery pack may waste numerous battery cells that are still operating in a desired range or manner.

The preceding description has been presented to illustrate and describe examples of the principles described. This description is not intended to be exhaustive or to limit these principles to any precise form disclosed. Many modifications and variations are possible in light of the above teaching.

What is claimed is:

1. A battery pack comprising:
a housing with an interior chamber that is selectively accessible;
a number of battery cell sleeves within the housing that receive a number of battery cells;
a number of electrical contacts within the housing that establish an electrical connection between the battery cells and an electrical device; and
a connector attached to the housing that selectively attaches the battery pack to the electrical device.

2. The battery pack of claim 1, in which the battery cell sleeves are selectively removable from the housing, further comprising a fastener that selectively attaches the battery cell sleeves to the housing.

3. The battery pack of claim 1, in which a first portion of the battery cell sleeves receive the battery cells in a first orientation and in which a second portion of the battery cell sleeves receive the battery cells in a second orientation that is opposite the first orientation.

4. The battery pack of claim 1, further comprising an alignment mechanism that determines if the battery cells are aligned in the appropriate orientation.

5. The battery pack of claim 4, in which the alignment mechanism further comprises a number of selectively removable caps that fit one end of the battery cells.

6. The battery pack of claim 1, in which the connector further comprises a twisting connector that engages the electrical device, and, following rotation of at least a portion of the twisting connector, selectively attaches the battery pack to the electrical device.

7. The battery pack of claim 6, in which the twisting connector further comprises:
a number of posts extending from a surface of the housing; and
a number of plates attached to the number of posts such that they are offset from the surface of the housing.

8. The battery pack of claim 1, in which the number of battery cell sleeves are secured to one another.

9. The battery pack of claim 1, further comprising electrical circuitry that establishes an electrical connection between the individual battery cells.

10. The battery pack of claim 1, further comprising a locking mechanism that selectively locks the battery pack in position relative to the electrical device.

11. A battery pack comprising:
a housing;
a number of battery cells contained within the housing; and
an adaptor that comprises:
a device connector that selectively attaches the adaptor to an electrical device; and
a housing connector that selectively attaches the adaptor to the housing.

12. The battery pack of claim 11, in which the adaptor further comprises:
a first electrical coupler that establishes an electrical connection to the electrical device; and
a second electrical coupler that establishes an electrical connection to the battery cells;
in which the first and second electrical couplers are electrically coupled to one another.

13. The battery pack of claim 11, in which the housing connector further comprises a twisting connector that engages the adaptor and following rotation of at least a portion of the twisting connector selectively attaches the battery pack to the adaptor.

14. The battery pack of claim 13, in which the twisting connector further comprises a number of plates attached to a number of posts, in which the posts offset the plates from the surface of the housing.

15. The battery pack of claim 14, in which the plates have one orientation for attachment to an electrical device.

16. A cordless power kit, comprising:
a battery pack selectively attachable to an electrical device that electrically couples to the electrical device further comprising;
a housing that is selectively accessible;
a number of battery cell sleeves within the housing that receive a number of battery cells;
a number of battery cells insertable into the battery cell sleeves that are independently interchangeable relative to the other battery cells; and
a number of adaptors comprising:
a number of electrical contacts that establish an electrical connection between the battery pack and the electrical device; and
a number of connectors that selectively attach the battery pack to the electrical device.

17. The kit of claim 16, in which the connector is a twisting connector that engages the electrical device and following rotation of at least a portion of the twisting connector selectively attaches a battery pack to the electrical device.

18. The kit of claim 16, in which a portion of the adaptors are formed to match configurations of any number of brands of electrical devices.

19. The kit of claim 18, in which the adaptor further comprises the twisting connector, and following rotation of at least a portion of the twisting mechanism selectively attaches the battery pack to the adaptor.

20. The kit of claim 18, further comprising electrical circuitry that establishes an electrical connection between the individual battery cells.
